(19) United States
(12) Patent Application Publication
(10) Pub. No.: US 2010/0053007 A1
(43) Pub. Date: Mar. 4, 2010

(54) TUNABLE DUAL-BAND ANTENNA USING LC RESONATOR

(75) Inventors: Nan Ni, Santa Barbara, CA (US); Albert Humirang Cardona, Santa Barbara, CA (US)

Correspondence Address: FENWICK & WEST LLP, SILICON VALLEY CENTER, 801 CALIFORNIA STREET, MOUNTAIN VIEW, CA, 94041, US

(73) Assignee: AGILE RF, INC., Goleta, CA (US)

(21) Appl. No.: 12/545,549

(22) Filed: Aug. 21, 2009

Related U.S. Application Data
(60) Provisional application No. 61/093,151, filed on Aug. 29, 2008.

(51) Int. Cl. H01Q 1/38; H01Q 9/00

(52) U.S. Cl. 343/745; 343/700 MS

(57) ABSTRACT

An Inverted-F antenna (IFA) includes a tunable parallel LC resonator physically inserted between two antenna bodies of the IFA structure. The LC resonator is comprised of a tunable capacitor C1 connected in parallel with a combination of a DC blocking capacitor C2 and an inductor L1 connected in series to each other. A DC bias voltage is applied to the tunable capacitor C1 through a DC bias resistor R1, in order to adjust the capacitance of the tunable capacitor C1. The IFA exhibits dual band characteristics, and its resonant frequencies and bandwidths may be turned by adjusting the capacitance of the tunable capacitor C1. The tunable capacitor C1 may be a BST capacitor.

### CROSS-REFERENCE TO RELATED APPLICATION

This application claims priority under 35 U.S.C. §119(e) from co-pending U.S. Provisional Patent Application No. 61/093,151, entitled “Tunable Dual-Band Antenna Using LC Resonator,” filed on Aug. 29, 2008, which is incorporated by reference herein in its entirety.

### BACKGROUND OF THE INVENTION

1. Field of the Invention

The present invention relates to a tunable dual-band antenna using LC resonators.

2. Description of the Related Art

Wireless communication systems used in different geographical regions require different frequency bandwidths. For example, in Europe, the GSM-900 standard has frequency bands of 890-915 MHz and 935-960 MHz for the uplink and downlink, respectively. The GSM-1800 (also called DCS-1800) uses 1710-1785 MHz and 1805-1880 MHz for the uplink and downlink, respectively. In North America, GSM-850 uses 824-849 MHz for the uplink and 869-894 MHz for the downlink. And GSM-1900 (also called PCS-1900) uses 1850-1910 MHz for the uplink and 1930-1990 MHz for the downlink. For 3G wireless systems, UMTS in Europe uses 1900-1980 MHz, 2010-2025 MHz, and 2110-2170 MHz bands for terrestrial transmission. In North America, CDMA 2000 uses 824-849 869-894 MHz, 1850-1910 MHz, and 1930-1990 MHz.

Thus, for a cellular telephone to be compatible with the various systems, the antenna of the cellular telephone should be able to operate in multiple ones of these bands. Tunable dual-band antennas have drawn considerable research interests since they can be tuned to operate in different frequency bands. An inverted-F antenna (IFA) is a variation of a transmission line antenna with an offset feed that provides for adjustment of the input impedance, and is used as the antenna for many cellular telephones.

FIG. 1 illustrates a conventional Inverted-F antenna (IFA). The IFA 100 includes a shorted end 112 connected to a ground plane (not shown), an RF signal port 108, and an open end 114. RF signal port 108 connects to an RF component (not shown) that provides the RF signal to be radiated via antenna 100 or receives the RF signal captured at antenna 100. However, the conventional IFA 100 operates in a single frequency band and is not tunable.

### SUMMARY OF THE INVENTION

Embodiments of the present invention include an Inverted-F antenna (IFA) including a tunable parallel LC resonator physically inserted between two antenna bodies (sections) of the IFA antenna structure. The LC resonator is comprised of a tunable capacitor C1 connected in parallel with a combination of a DC blocking capacitor C2 and an inductor L1 connected in series with each other. A DC bias voltage is applied to the tunable capacitor C1 through a DC bias resistor R1 in order to adjust the capacitance of the tunable capacitor C1.

The resonant frequency of the LC resonator is mainly decided by the values of the inductor L1 and the tunable capacitor C1. The function of the LC resonator is to equate the impedance of antenna bodies at both ends of the resonator. For one capacitance of C1 and one inductance of L1, the parallel LC resonator equates the impedances of the antenna bodies at two different frequencies, thus realizing the dual-band characteristic. Since the capacitance C1 is tunable, the antenna of the present invention can equate the impedance of both antenna bodies at two different frequencies that are tunable, thus realizing tunable, dual-band characteristics. The capacitor C1 may be implemented as a Barium Strontium Titanate (BST) capacitor.

The IFA according to the present invention has the advantage that it achieves dual-band characteristics with only one radiation element. In addition, the frequencies of the dual band may be tunable. Also, the IFA has a planar structure that can be easily incorporated into cell phones or other wireless devices.

### BRIEF DESCRIPTION OF THE DRAWINGS

The teachings of the embodiments of the present invention can be readily understood by considering the following detailed description in conjunction with the accompanying drawings.

FIG. 1 illustrates a conventional Inverted-F antenna (IFA).

FIG. 2 illustrates a tunable dual-band IFA, according to one embodiment of the present invention.

FIG. 3 illustrates the tunable LC resonator of the tunable dual-band IFA in more detail, according to one embodiment of the present invention.

FIG. 4A illustrates the two sections of the tunable dual-band IFA of FIG. 2, according to one embodiment of the present invention.

FIG. 4B illustrates the approximate transmission line model of the tunable dual-band IFA of FIG. 4A.

FIG. 5A illustrates the entire bandwidth covered by the lower band and upper band of the tunable dual-band IFA of FIG. 4A.

FIG. 5B illustrates the entire bandwidth covered by the lower band of the tunable dual-band IFA of FIG. 4A, with the tunable capacitor in the LC resonator biased at two different DC voltages.

FIG. 5C illustrates the entire bandwidth covered by the upper band of the tunable dual-band IFA of FIG. 4A, with the tunable capacitor in the LC resonator biased at two different DC voltages.

FIG. 6 illustrates a metal-insulator-metal (MIM) parallel plate configuration of a thin film BST capacitor according to one embodiment of the present invention.

FIG. 7A is a graph illustrating a tuning curve for the BST capacitor of FIG. 6.

FIG. 7B is an equivalent circuit model for the BST capacitor of FIG. 6.

### DETAILED DESCRIPTION OF EMBODIMENTS

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the present invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

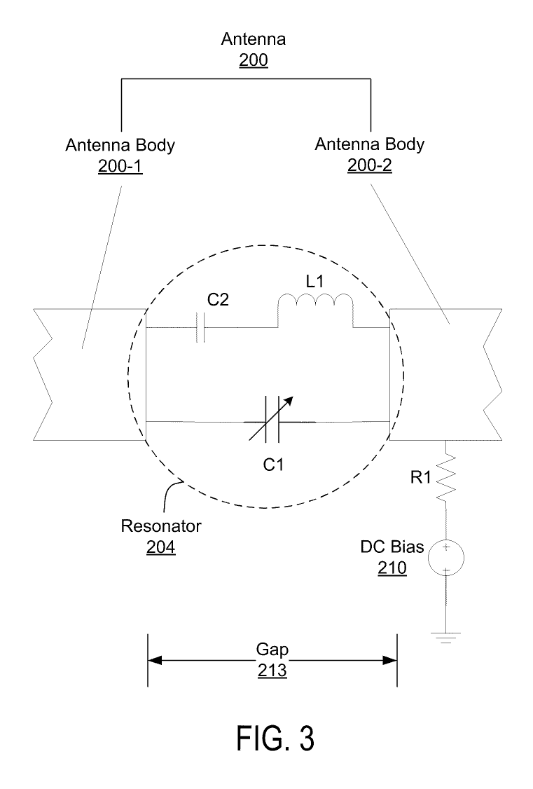

FIG. 2 illustrates a tunable dual-band IFA according to one embodiment of the present invention. The antenna 200 is a modification of the conventional Inverted-F Antenna (IFA). The IFA 200 (the part above dotted line 222) includes a shorted end 212 connected to a ground plane 202 (below dotted line 222), an RF signal port 208, an open end 214, a variable (tunable) LC resonator 204 physically inserted in a gap 213 formed within the antenna 200, and a DC (direct current) bias resistor 206 through which a DC bias voltage 210 is applied to the variable LC resonator 204. RF signal port 208 connects to an RF component (not shown) that provides the RF signal to be radiated via antenna 200 or receives the RF signal captured at antenna 200. The antenna 200 and the ground plane 202 are made on the same metal plane.

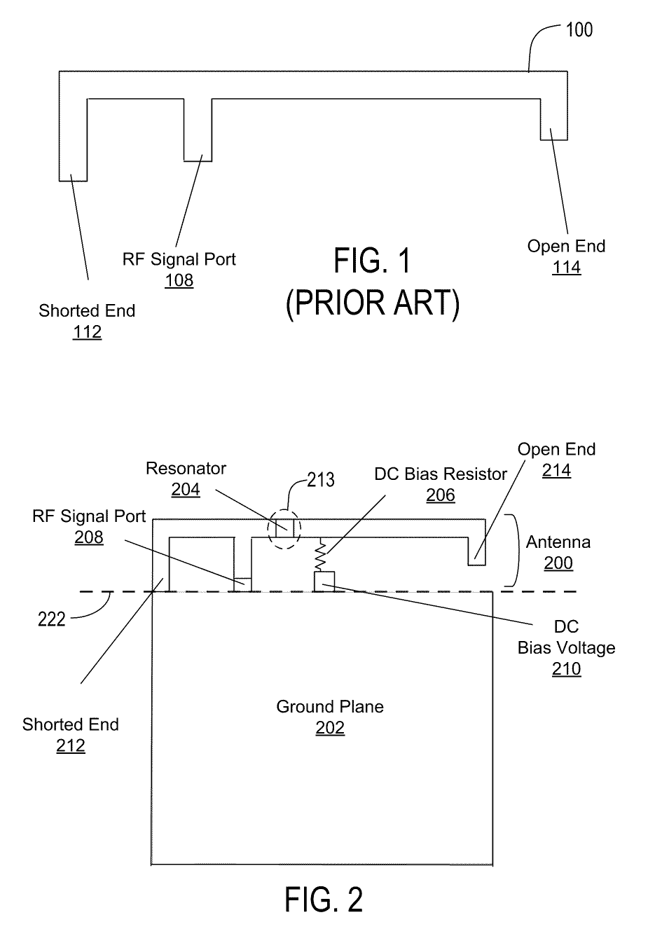

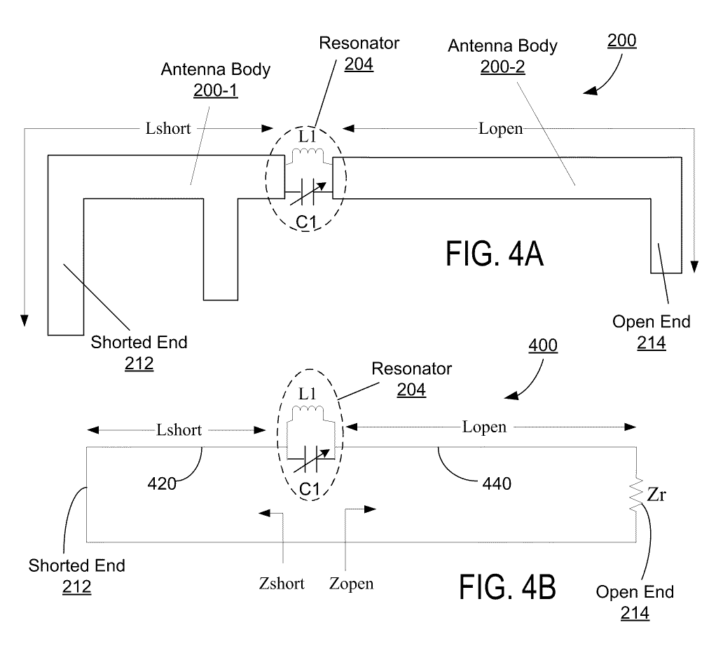

The difference between the antenna 200 of the present invention and the conventional IFA 100 of FIG. 1 is that the antenna 200 of the present invention has a gap 213 in its main body in order to place the variable LC resonator 204. In addition, there is a DC bias resistor 206 on the antenna 200 so that a DC bias voltage 210 can be applied to change the capacitance of a BST tunable capacitor (not shown in FIG. 2 but shown in FIG. 3) in the LC resonator 200.

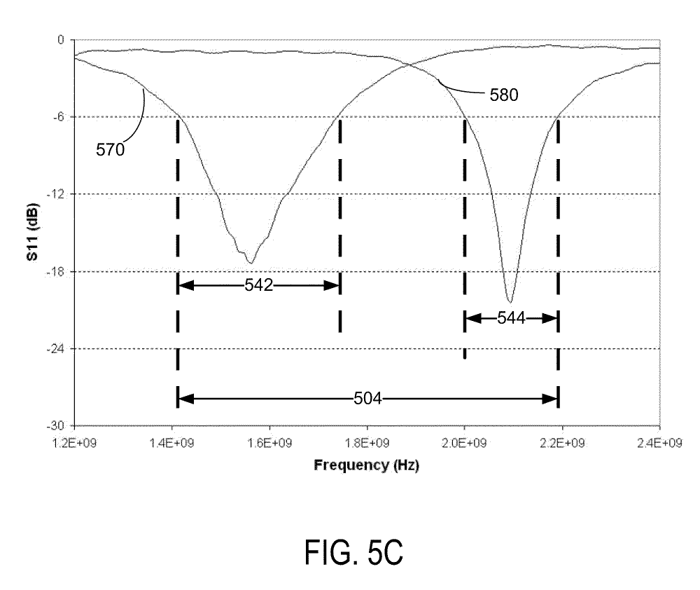

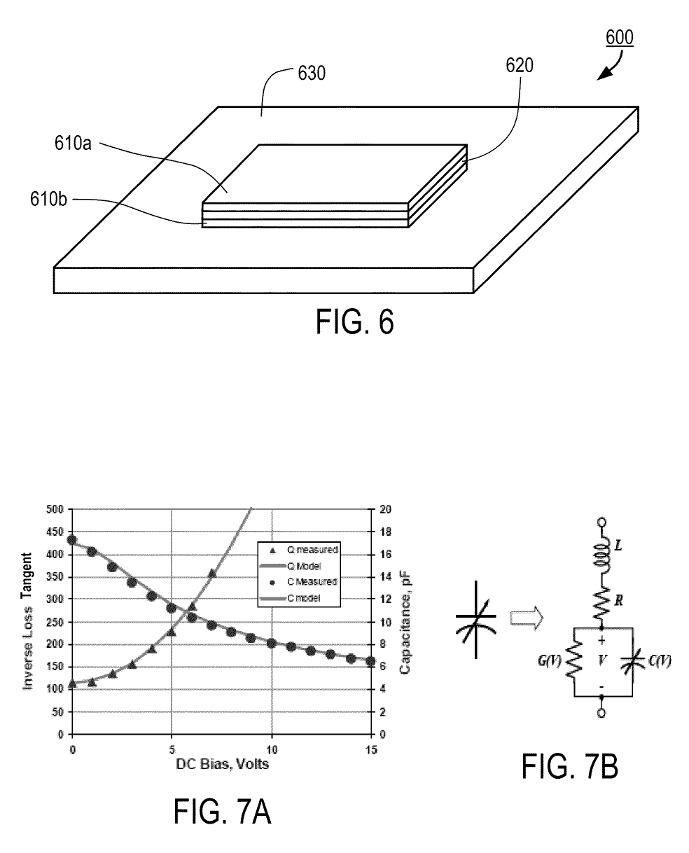

FIG. 3 illustrates the tunable LC resonator of the tunable dual-band IFA in more detail, according to one embodiment of the present invention. The IFA 200 of the present invention incorporates a parallel LC resonator 204 to realize tunable dual-band characteristics in the IFA 200. The resonator 204 is inserted within a gap 213 that is physically formed between two sections (antenna bodies) 200-1, 200-2 of the antenna 200. Resonator 204 includes a tunable capacitor C1, a fixed DC blocking capacitor C2, and an inductor L1. In one embodiment, tunable capacitor C1 is a BST tunable capacitor using BST (Barium Strontium Titanate) as its dielectric. As will be explained in greater detail below with reference to FIGS. 6, 7A, and 7B, BST has permittivity that depends on the applied electric field. Thus, tunable capacitor C1 is a voltage-variable capacitor (varactor) of which the capacitance can be changed by varying the DC bias voltage across the tunable capacitor C1. The DC bias voltage 210 is applied to the tunable capacitor C1 through the DC bias resistor R1 to adjust the capacitance of tunable capacitor C1.

Capacitor C2 and inductor L1 are connected in series to each other. Also, tunable capacitor C1 is connected in parallel to the combination of capacitor C2 and inductor L1. Capacitor C2 is a DC blocking capacitor used to block the DC bias voltage 210 from the inductor L1, so that the tunable capacitor C1 is not be shorted through its parallel-connected inductor L1.

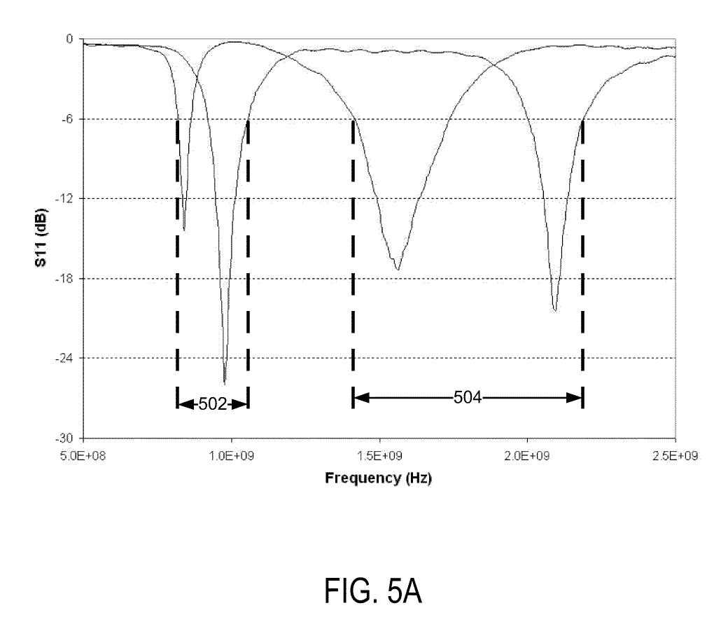

FIG. 4A illustrates the two sections (antenna bodies) of the tunable dual-band IFA of FIG. 2. In FIG. 4A, DC blocking capacitor C2 is omitted since the electrical characteristics of the LC resonator 204 is mainly determined by inductor L1 and variable capacitor C1. Antenna sections 200-1, 200-2 are shown as having electrical lengths Lₛₕₒᵣₜ and Lₒₚₑₙ, respectively. An approximate analysis of the IFA 200 can be obtained by utilizing a transmission-line model.

FIG. 4B illustrates the approximate transmission line model of the tunable dual-band IFA of FIG. 4A. The entire IFA 400 can be modeled as two transmission lines 440, 420 of characteristic impedance Z₀ with electrical lengths Lₒₚₑₙ and Lₛₕₒᵣₜ, respectively. Transmission line 440 connects the open end 214 to the resonator 204, and transmission line 420 connects the shorted end 212 to the resonator 204. The open end 214 can be modeled as a load Zᵣ while the shorted end 212 can be modeled as a shorted transmission line. The lengths Lₒₚₑₙ and Lₛₕₒᵣₜ are determined by the physical dimensions of the antenna bodies 200-2, 200-1, respectively, of antenna 200. The parallel LC resonator 204 can be thought of as being equivalent to an electrical length L_{LC}(f) that depends on the frequency f. At frequencies above its resonant frequency, the resonator 204 becomes capacitive and effectively decreases the electrical length of the antenna 200. At frequencies below its resonant frequency, the resonator 204 becomes inductive and effectively increases the electrical length of the antenna 200.

Referring to FIGS. 4A and 4B, adding the lengths Lₒₚₑₙ, Lₛₕₒᵣₜ and L_{LC}(f), the resonance of the antenna 200 can be determined by:

Lₒₚₑₙ+Lₛₕₒᵣₜ+L_{LC}(f)=λ/4 (Equation 1),

where λ is the wavelength of the RF signal to be radiated by antenna 200. Since L_{LC}(f) can have negative and positive effective electrical lengths, dual resonance can be achieved. Determining the values of inductor L1 and tunable capacitor C1 for producing dual resonance can be carried out by considering the impedance along IFA 200. For one fixed value of C1 and one fixed value of L1, the impedance Z_{lc}(f) of the resonator 204 is:

$${Z}_{lc} ( f ) = {( \frac{1}{jω L 1} + j ω C 1 )}^{- 1} . \qquad ( Equation 2 )$$

By defining Zₒₚₑₙ(f) and Zₛₕₒᵣₜ(f) as the impedances seen from the LC resonator 204 looking into the open end 214 and the shorted end 212, respectively, at frequency f, the following equation holds:

Z_{ic}(f)=Zₛₕₒᵣₜ(f)−Zₒₚₑₙ(f) (Equation 3),

as the condition for resonance at both frequencies f₁ and f2. Solving the above Equation 3 at frequencies f₁ and f₂, the following expressions for L1 and C1 are obtained:

$$\begin{matrix}L 1 = \frac{- 3 j}{4 π {f}_{1}} \frac{{Z}_{LC} ( {f}_{2} ) {Z}_{LC} ( {f}_{1} )}{2 {Z}_{LC} ( {f}_{2} ) - {Z}_{LC} ( {f}_{1} )} & ( Equation 4 ) \\ C 1 = \frac{- j}{2 π {f}_{1}} ( \frac{1}{{Z}_{LC} ( {f}_{1} )} - \frac{1}{j 2 π {f}_{1} L 1} ) & ( Equation 5 )\end{matrix}$$

Since capacitor C1 is tunable, by varying the capacitance of capacitor C1, the above Equations 4 and 5 will hold for two different frequencies, meaning that the antenna 200 has tunable dual-frequency characteristic.

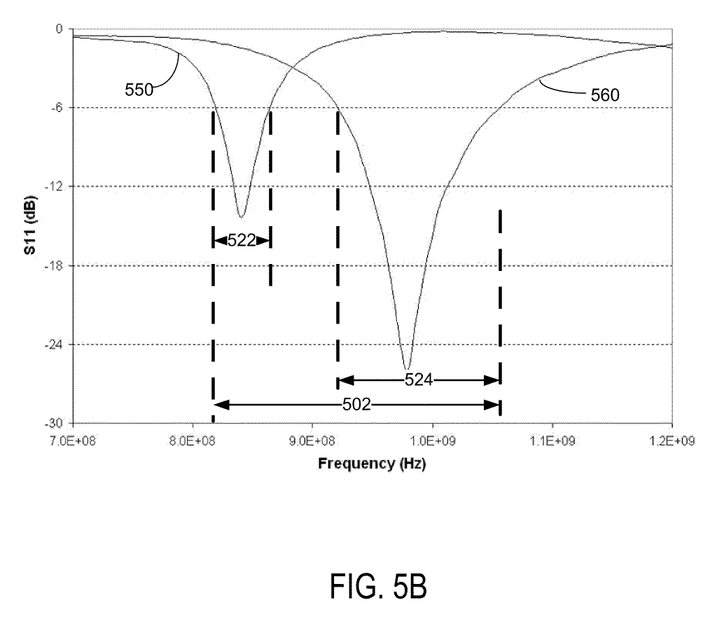

FIG. 5A illustrates the entire bandwidth covered by the lower band and upper band of the tunable dual-band IFA of FIG. 4A. FIG. 5A uses −6 dB as the criterion for return loss, S11. The lower band 502 covers the range from 822 MHz to 1.05 GHz. The upper band 504 covers the range from 1.42 GHz to 2.19 GHz. As expected from above, the IFA 200 of FIGS. 2 and 4A exhibits dual-band characteristics. The lower band 502 has enough bandwidth to cover the GSM-850 and GSM-900 bandwidths. The upper band 504 has enough bandwidth to cover the GPS, DCS, PCS, and UMTS bandwidths.

FIG. 5B illustrates the entire bandwidth covered by the lower band 502 of the tunable dual-band IFA antenna of FIG. 4A, with the tunable capacitor in the LC resonator biased at two different DC voltages. Line 550 represents the return loss S11 when 0 volt DC voltage is applied to the tunable capacitor C1, or in other words, when the BST tunable capacitor C1 has its largest value, resulting in a bandwidth 522. Line 560 represents the return loss S11 when the highest DC bias voltage is applied to the variable capacitor C1, or in other words, when the BST tunable capacitor C1 has its smallest value, resulting in bandwidth 524. Any other DC bias voltage 210 (or any other capacitance C1) will result in a bandwidth in between these two bandwidths 522, 524. Therefore, the lower band 502 is tunable by applying different DC bias voltages 210 and its total bandwidth is range 502.

FIG. 5C illustrates the entire bandwidth covered by the upper band of the tunable dual-band IFA antenna of FIG. 4A, with the variable capacitor in the LC resonator biased at two different DC voltages. Line 570 represents the return loss S11 when 0 volt DC voltage is applied to the variable capacitor C1, or in other words, when the BST tunable capacitor C1 has its largest value, resulting in bandwidth 542. Line 580 represents the return loss S11 when the highest DC voltage is applied to the variable capacitor C1, or in other words, when the BST tunable capacitor C1 has its smallest value, resulting in bandwidth 544. Any other DC bias voltage 210 (or any other capacitance C1) will result in a bandwidth in between these two bandwidths 542, 544. Therefore, the upper band 504 is tunable by applying different DC bias voltages 210, and its total bandwidth is range 504.

FIG. 6 illustrates a metal-insulator-metal (MIM) parallel plate configuration of a thin film BST capacitor according to one embodiment of the present invention. Such BST capacitor 600 may be used as the tunable BST capacitor C1 in FIGS. 3 and 4A. Referring to FIG. 6, capacitor 600 is formed as a vertical stack comprised of a metal base electrode 610b supported by a substrate 630, BST dielectric 620, and a metal top electrode 610a. The lateral dimensions, along with the thickness of the BST dielectric 620, determine the capacitance value of the BST capacitor 600.

BST generally has a high dielectric constant so that large capacitances can be realized in a relatively small area. Furthermore, BST has a permittivity that depends on the applied electric field. As a result, voltage-variable capacitors (varactors) can be produced by changing the DC bias voltage across the BST capacitor 600. In addition, the bias voltage of the BST capacitor 600 can be applied in either direction across a BST capacitor since the film permittivity is generally symmetric about zero bias. That is, BST dielectric 620 does not exhibit a preferred direction for the electric field. One further advantage is that the electrical currents that flow through BST capacitors are relatively small compared to other types of semiconductor varactors.

FIG. 7A is a graph illustrating a tuning curve for the BST capacitor 600. FIG. 7A shows the dependence of both capacitance and dielectric loss (inverse loss tangent) of the BST capacitor 600 upon the DC bias voltage applied to the BST capacitor 600. As shown in FIG. 7A, the capacitance (C) of the BST capacitor 600 decreases from approximately 16.5 pF to approximately 6 pF as the DC bias voltage applied to the BST capacitor 600 varies from 0 volt to 15 volts. Also, the inverse of the loss tangent (i.e., Q_{BST}=1/tan δ) is greater than 100. Thus, the capacitance of the BST capacitor 600 can be tuned by simply changing the applied DC bias voltage.

FIG. 7B is an equivalent circuit model for the BST capacitor of FIG. 6. The model in FIG. 7B captures the loss elements and the large signal properties of the BST capacitor 600. The material non-linearities are described by the parallel combination of the conductance G(V) and the capacitance C(V). An empirical model that adequately defines the C-V and Q-V tuning curves of FIG. 7A is given by:

$$\begin{matrix}C ( V ) = \frac{{C}_{0}}{\sqrt[3]{1 + {( V / {V}_{m} )}^{2}}} & ( Equation 6 ) \\ G ( V ) = \frac{ω C ( V )}{{Q}_{BST} ( V )} & ( Equation 7 ) \\ {Q}_{BST} ( V ) = \frac{1}{tan δ} = {Q}_{0} ( 1 + {qV}^{2} ) & ( Equation 8 )\end{matrix}$$

where C₀, Vₘ, Q₀ and q are fitting parameter constants. The simulation results for this model is shown in FIG. 7A as well, overlayed with the actual measured results. The thickness and material composition (Ba/Sr ratio) of the BST layer 620 are primary factors in determining the tunability at a given voltage and hence Vₘ. The film quality factor Q_{BST} can be determined from low-frequency (1 MHz) impedance measurements or by extrapolating on-wafer RF data to low frequencies. The high-frequency loss of the BST capacitor 600 depends on both the loss tangent of the dielectric 620 and the conductor loss of the metal layers 610a, 610b, modeled by the series resistance R in FIG. 7B. A Q-factor can be associated with the conductor loss alone, denoted as Q_{c}, in which case the overall Q-factor of the BST capacitor 600 and the series resistance can be written as:

$$\frac{1}{{Q}_{total}} = \frac{1}{{Q}_{c}} + \frac{1}{{Q}_{BST}} and R = \frac{1}{ω {Q}_{c} C} . \qquad ( Equation 9 )$$

The series inductance L can be determined by measurement of the self-resonant frequency of the BST capacitor 600, with the stray reactive parasitic capacitance arising from on-wafer probe contacts removed.

The IFA according to the present invention has the advantage that it achieves dual-band characteristics with only one radiation element. In addition, such dual bands are tunable simply by adjusting the DC bias voltage applied to the tunable capacitor of the LC resonator inserted in the IFA. Also, the IFA has a planar structure that can be easily incorporated into cell phones or other wireless devices.

Upon reading this disclosure, those of skill in the art will appreciate still additional alternative designs for a tunable, dual-band antenna. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention.

What is claimed is:

1. A tunable dual-band antenna comprising:
a first antenna section;
a second antenna section; and
a tunable resonator inserted between the first antenna section and the second antenna section, the tunable resonator configured to substantially equate impedances of the first antenna section and the second antenna section at a first frequency and a second frequency.

2. The tunable dual-band antenna of claim 1, wherein the tunable resonator includes an inductor and a tunable capacitor coupled in parallel with the inductor.

3. The tunable dual-band antenna of claim 2, wherein the tunable capacitor is a BST (Barium Strontium Titanate) capacitor including BST dielectric, and the capacitance of the BST capacitor is tunable by adjusting a DC bias voltage applied to the BST dielectric.

4. The tunable dual-band antenna of claim 3, further comprising a resistor, the DC bias voltage being applied to the BST dielectric through the resistor.

5. The tunable dual-band antenna of claim 2, further comprising a fixed capacitor coupled in series with the inductor, the tunable capacitor being coupled in parallel with a combination of the inductor and the fixed capacitor coupled in series with each other, and the fixed capacitor configured to block the DC bias voltage from the inductor to prevent the tunable capacitor from being shorted through the inductor.

6. The tunable dual-band antenna of claim 1, wherein:
the antenna is an inverted-F antenna;
the first antenna section includes a shorted end connected to a ground plane and a radio frequency (RF) signal port coupled to an RF component that is configured to provide an RF signal to be radiated by the antenna or receive the RF signal captured by the antenna; and
the second antenna section includes an open end.

7. The tunable dual-band antenna of claim 6, wherein the antenna and the ground plane are made on a same metal plane.

8. The tunable dual-band antenna of claim 1, wherein the tunable resonator is inserted within a gap that is physically formed between the first antenna section and the second antenna section.

9. A tunable dual-band inverted-F antenna comprising:
a first antenna section including a shorted end connected to a ground plane and a radio frequency (RF) signal port coupled to an RF component that is configured to provide an RF signal to be radiated by the antenna or receive the RF signal captured by the antenna;
a second antenna section including an open end; and
a tunable resonator including an inductor and a tunable capacitor coupled in parallel with the inductor, the tunable resonator inserted between the first antenna section and the second antenna section and configured to substantially equate impedances of the first antenna section and the second antenna section at a first frequency and a second frequency.

10. The tunable dual-band inverted-F antenna of claim 9, wherein the tunable capacitor is a BST (Barium Strontium Titanate) capacitor including BST dielectric, and the capacitance of the BST capacitor is tunable by adjusting a DC bias voltage applied to the BST dielectric.

11. The tunable dual-band inverted-F antenna of claim 10, further comprising a resistor, the DC bias voltage being applied to the BST dielectric through the resistor.

12. The tunable dual-band inverted-F antenna of claim 9, further comprising a fixed capacitor coupled in series with the inductor, the tunable capacitor being coupled in parallel with a combination of the inductor and the fixed capacitor coupled in series with each other, and the fixed capacitor configured to block the DC bias voltage from the inductor to prevent the tunable capacitor from being shorted through the inductor.

13. The tunable dual-band inverted-F antenna of claim 9, wherein the antenna and the ground plane are made on a same metal plane.

14. The tunable dual-band inverted-F antenna of claim 9, wherein the tunable resonator is inserted within a gap that is physically formed between the first antenna section and the second antenna section.
